(19) United States
(12) Patent Application Publication
(10) Pub. No.: US 2012/0118163 A1
(43) Pub. Date: May 17, 2012

(54) Audible Indicator of Air Filter Status

(76) Inventor: Aaron Gorga, St. Louis, MO (US)

(21) Appl. No.: 12/947,996

(22) Filed: Nov. 17, 2010

(51) Int. Cl. B01D 46/42; G01D 21/00

(52) U.S. Cl. 96/419; 116/208

(57) ABSTRACT

A notifier device and method of use which can be placed into an air filter for an HVAC system and which produces a whistling sound when the filter needs replacement. The device generally forms an air pathway and includes a resonator so that air passing through the pathway creates a whistling sound. So as to be useable with different types of filter media (113), the device can include a door which can selectively open and close the air pathway depending on the air pressure differential desired to be detected.

### BACKGROUND OF THE INVENTION

1. Field of the Invention

This disclosure relates to the field of air filtration in Heating Ventilation and Air Conditioning (HVAC) systems. Particularly, to a device which produces an audible signal when an air filter has become sufficiently clogged with debris as to require replacement.

2. Description of Related Art

It is well known that as we inhale, particulates, vapors, microorganisms, and other materials are inhaled from the air around us. Materials being suspended in the air around us, and inhaled and exhaled during respiration, is completely natural and the vast majority of animals, humans included, have adapted to respiration causing the inhalation of various materials. The sense of smell, for example, requires that particulates of materials be inhaled and detected by appropriate organs to allow us to determine what is occurring in our surroundings and sample the air we are in.

While the inclusion of such matter in the air is natural, It is well known that many humans have reactions to the respiration of certain materials. Allergens (such as cat dander or tree pollen) can produce unpleasant immune responses in those who are sensitive to them. Other materials, such as dust or dirt, can make breathing unpleasant even if the particulates don't necessarily cause an immune response. In certain extreme cases, for instance around large fires, air can become dangerous or deadly due to suspended matter therein.

Suspended materials can be particularly problematic to humans living and working within confined spaces. In offices, homes, and other buildings, the structure is often designed to be relatively airtight when doors, windows, and the like are sealed to provide for insulation and better environmental control. In many large office buildings, floors above the ground often have no direct access to outside air. Such sealing, however, requires that air be provided to the structure under controlled circumstances and that air to be circulated through the building be cleaned of materials to prevent particulate buildup in the internal air and the air potentially becoming dangerous.

Commonly, buildings are supplied with air via a Heating, Ventilation, and Air Conditioning (HVAC) system. This system is generally designed to take in air (whether external or recirculated), clean it, provide for a temperature alteration (heating or cooling) as necessary and then provide the air into the structure. The HVAC unit, therefore acts as the source of the air for the structure.

It is important for an HVAC unit to have a filtration system to allow for the removal of material in the air that it is handling. The reason is generally three-fold. First, since air is not regularly exhausted from within the building, if the air was not filtered the concentration of materials in the air in the structure would generally increase over time due to the human activity in the building and the fact that there is nowhere for the suspended material to go once it is inside the environment. This could even get to the point where the air in the structure became dangerous.

The second reason is that makeup air pulled in from the environment will generally have suspended material that may otherwise avoid contact from humans. HVAC systems are often mounted on the roof of buildings and as many office buildings and other places of work are near places where additional suspended material can be input into the air (for example smokestacks of industry), without filtration, the air inside the building can quickly become contaminated with exterior pollutants which were supposed to dissipate within the atmosphere.

Thirdly, beyond the materials being provided to occupants, material which is not filtered out can begin to accumulate on mechanical parts of the HVAC system as it handles the air. Because an HVAC system generally handles the entire air flow of a relatively large structure, the total amount of particulates present on its internal surfaces can be far greater than for a normal surface. This can cause parts to become coated with materials, have increased friction, and run less efficiently creating a strain on the system which can provide for increased system breakdown and maintenance, as well as causing the system to take more energy, and thus money, to operate.

Because there are so many reasons to make sure that the air passing through an HVAC system has reduced material concentrations, most HVAC systems, from small residential units to large multi-function units used in commercial and industrial facilities, generally include an air filter to clean the input air.

While there are numerous forms of highly advanced filtration systems such as ionizers, cyclone separators, and static electric systems, by far the most common for particulate removal is the simple mesh filter. Generally, an air filter is a relatively thin sheet of material which provides for a large number of very small holes through it. These holes are often in the form of a complicated pathway through the material. Because of its ease of construction, many filter materials are some form of fabric or other woven or spun material where the space between the threads in the fabric serves to provide for the passage of air while the threads themselves serve as the walls of associated gaps. Many filters utilize fiberglass, polyester, wood, or other fiber structures which are spun into a mat as their principle structure.

The spaces in such a mat are generally too small (often on the order of microns) for most particulates to pass through as the air is pushed through the filter. The air molecules, however, which are much smaller, and can easily pass through the gaps relatively unobstructed. Thus, the filter allows the gases in the fluid air to pass through the filter surface while a relatively large percentage of the suspended particulates become trapped. In some filters, an adhesive or material of increased friction is also provided in the filter so that particulates are more inclined to “stick” to a filter surface.

While a filter is supposed to allow for free air passage, in reality, any form of filter necessarily imposes a constriction on air flow. In particular, the passage of the air through the holes, while it is allowed, will generally require some constriction of the gases due to the reduction in available space for them to occupy. Further, the passage of the gas through a convoluted pathway often causes increased molecular impact as the gas molecules navigate the path. Thus, most HVAC systems will provide a system whereby there is a positive or negative pressure created on one surface of the filter to force air through the filter.

It should be generally apparent that as a filter retains more and more material from the air, the number and size of available holes will decrease. This is caused by a variety of effects including the simple action of particulates becoming lodging in and blocking the holes (which is what should happen in a well designed filter) to effects such as “face-loading” where the particulates form a surface on the exterior of the filter which surface is much more uniform than the filter is and prevents air from getting to the filter media (113) at all.

Because the building up of material in a filter is the natural and expected result of successful filtration, filters need to be replaced (or in some cases washed) periodically. If they are not, the motors and other components of the HVAC system which are used to draw air through the filter will becoming increasingly strained to try and force air through the filter.

The replacement of filters is generally recommended on a time basis (e.g. every month, every three months, etc.) based upon the air conditions, the type of filter, and the nature of the filtration being performed. This time period methodology provides that the filter is generally replaced prior to it becoming overly clogged and causing a concern over increased work on the HVAC components, causing it to cease its useful function or resulting in a significant decrease in effective filtration. However, it does require record keeping to make sure that the filter is periodically replaced and such record keeping can be difficult for individuals and businesses that may have priorities elsewhere.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of the above described and other problems in the art, described herein is a system and method for alerting a user when an air filter has become sufficiently clogged that it needs to be replaced. The notifier device can be placed into an air filter for an HVAC system and produces a whistling sound when the filter needs replacement. The device generally forms an air pathway and includes a resonator so that air passing through the pathway creates an audible whistling sound. So as to be useable with different types of filter media, the device can include a door which can selectively open and close the air pathway depending on the air pressure differential desired to be detected.

In an embodiment there is described herein, a device for indicating when an air filter should be replaced, the device comprising: an outside portion, the outside portion comprising an accumulator; an inner portion, the inner portion comprising a resonator; a hollow shaft connecting the inner portion and the outside portion such that air flows from the accumulator, through the shaft and through the inner portion such that the flow of air from the hollow shaft to the inner portion produces a whistling sound; and a door, the door being positioned to selectively prevent or allow air from exiting the inner portion.

In an embodiment of the device the accumulator forms a taper which is connected at a hole to the hollow shaft. The accumulator may comprises a hollow cone, a base of the cone having a hole in the center or may comprise a hollow hemisphere, a base the hollow hemisphere having a hole in the center.

In an embodiment of the device the resonator comprises a hollow cylinder.

In an embodiment of the device the hollow shaft comprises: a male connector; and a female connector; wherein the male connector and the female connector are connected in a press fit relationship to form the hollow shaft.

The male connector may be attached to the outside portion and the female connector may be attached to the inner portion. The male connector may comprise teeth wherein the teeth are inside the female connector when the male connector and the female connector are in the press fit relationship

In an embodiment of the device the door inhibits air from exiting the inner portion if the air flow from the inner portion is not sufficiently fast. The door may be held in the closed position by a biasing mechanism such as, but not limited to, a weight, spring, magnet, or similar structure or means.

In an embodiment of the device the door can be positioned in one of an open position or a closed position by a user wherein the weight may used to hold the door in a closed position when the device is placed by the user in an upright orientation and hold the door in an open position when the device in placed by the user in an orientation opposite the upright orientation.

In an embodiment of the device the resonator is a cavity resonator.

There is also described herein, in an embodiment, a combination air filter and device for indicating that the air filter should be replaced, the combination comprising: an air filter comprising a filter media; and a notification device comprising: an outside portion, the outside portion comprising an accumulator; an inner portion, the inner portion comprising a resonator; a hollow shaft connecting the inner portion and the outside portion such that air flows from the accumulator, through the shaft and through the inner portion; and a door, the door being positioned to selectively prevent or allow air from exiting the inner portion; wherein the outside portion is located on an upstream side of the filter; wherein the inner portion is located on a downstream side of the filter; wherein the hollow shaft penetrates the filter media; and wherein a flow of air through the device produces a whistling sound.

### BRIEF DESCRIPTION OF THE DRAWINGS

FIG. 1 provides a side view of an embodiment of a notifier with the two portions connected together.

FIG. 2A provides a front view of the outside portion of the notifier of FIG. 1. FIG. 2B provides a rear view of the same outside portion.

FIG. 3A provides a rear view of the inner portion of the notifier of FIG. 1. FIG. 3B provides a front view of the same inner portion.

FIG. 4 provides a side view of the embodiment of FIG. 1 with the two portions separated showing the press-fit connection.

FIG. 5 provides a perspective view of the embodiment of FIG. 1 with the two portions separated and the door open.

FIG. 6 provides a cut through view of the embodiment of FIG. 1 with the two portions connected together.

FIG. 7A provides an exploded view of the embodiment of FIG. 1, FIG. 7B shows a reverse view of the door assembly to show detail.

FIG. 8 shows a basic block indication of the ductwork of an HVAC system with a filter and notifier in place.

### DESCRIPTION OF THE PREFERRED EMBODIMENT(S)

The following description illustrates by way of example and not by way of limitation. Described herein, generally is a device, sometimes called a notifier, which can be used to detect the pressure differential between the two sides of an air filter, and when that differential reaches a predetermined value, produce an audible signal to notify that the filter needs to be replaced.

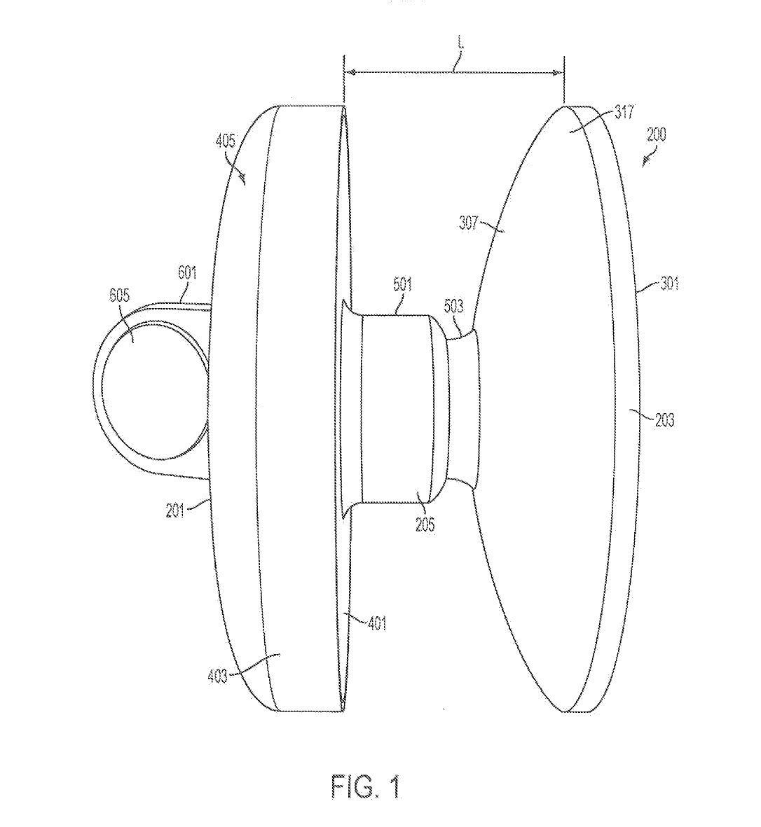

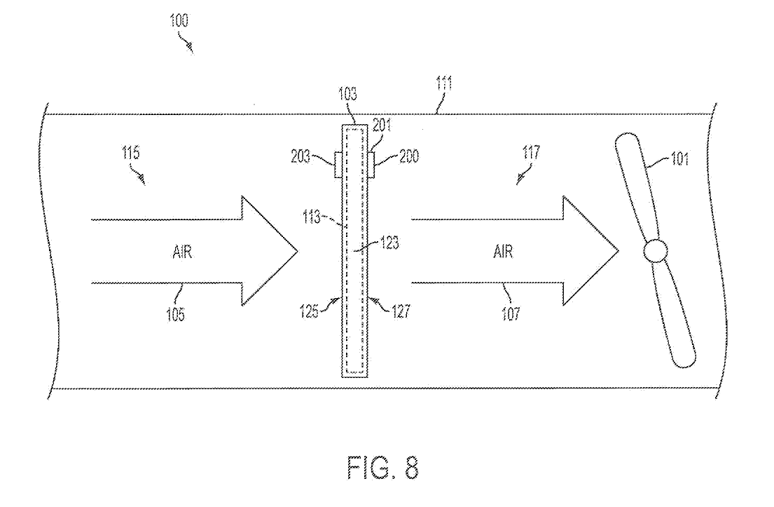

FIG. 8 shows a general block diagram of the internal layout of a filter system in an HVAC system (100). In FIG. 1, input air (105), which is upstream of the air filter (103), whether it is recycled air from the environment, or new outside air, is pulled into the duct work (111) by the action of fan (101). The air flow then passes through the filter (103) and the output air (107) which is downstream of the air filter (103) then passes through the remainder of the HVAC system.

It should be apparent that the fan (101) is able to draw air (107) into the unit (100) through the filter (103) by creating a pressure differential in the downstream space (117) when compared to the upstream space (115). Specifically, the fan (101), by pushing air further down the duct work (111), creates a slight vacuum in area (117) which serves to provide a pull force for getting air from upstream space (115) into downstream space (117) through the filter (103). Thus, an air flow is created by movement of the fan (101) moving air from upstream space (115) to downstream space (117) and then further through the unit (100). This movement of air also serves to filter the air as it passes through filter (103).

Is would be recognized by one of ordinary skill that while a fan (101) is the normal mechanism for moving air, air (105) can be sent into the filter (103) alternatively by having a fan or other object positioned in space (115) which serves to push air (105) into the filter (103), creating the same pressure differential in downstream space (117) as compared to upstream space (115). In both circumstances, the pressure in upstream space (115) is greater than in downstream space (117) and, thus, the air (105) will move from upstream space (115) to downstream space (117) through the filter (103) even though the filter (103) provides resistance to the movement.

The filter (103) generally comprises a frame (123) which support a filter media (113). The frame (123) will provide for a generally planar arrangement of the filter (103) with the frame (123) extending generally perpendicular to the ductwork (111). The media (113) will be held in position by the frame (123). The media (113) may be planar or may be arranged in a folded pattern (what is usually referred to as a pleated filter). The media (113), however, is generally constrained in the frame (123) and therefore the resultant filter (103) will usually have the generally planar shape. Air being forced into the filter (103) will generally be forced against the upstream face (125) of the filter, will pass through the filter media (113) and then pass out of the filter from the downstream face (127).

As the filter (103) becomes increasingly clogged with debris collected from the air (105) passing through it, the filter (103) will begin to present a greater hindrance to the air moving through it. Specifically, movement of the air (105) from upstream space (115) to downstream space (117) will generally require a greater pressure differential in order for the air (105) to move through the filter (103). As the fan (101) will essentially be constantly trying to decrease the air pressure in space (117) to maintain the air flow (107), this means that to move the same volume of air through the filter (103) in the same time, the fan (101) will have to work harder.

As time continues to pass and the filter (103) becomes additionally clogged, the air pressure differential between upstream space (115) and downstream space (117) will continue to increase. Eventually, the increase will become so significant, that the fan (101) will no longer be able to pull air (105) through the filter (103) in any reasonable form and the HVAC system (100) will essentially cease to have useful function.

In order to provide the user an indication that the filter (103) is to be replaced prior to system shutdown, a notifier (200) is placed in the filter. An example of the notifier (200) is shown in FIGS. 1-7. The notifier (200) generally works on the principle by providing a constricted but open path for air to flow through. This open path is provided through the filter media (113) and provides little to no hindrance to air movement. As the filter (103) becomes more clogged, air (105) will flow through the open path in increasing volume. The air flowing through the path can then be made to create whistling sound once the volume (speed) reaches a certain amount. In order to inhibit premature whistling, in certain types of filter media (113), the notifier (200) can include a component which serves to close off the air path, unless the volume flow reaches a certain minimum amount.

In order to allow for the air flow through the constriction to be used as a notifier, the device (200) includes a number of structures which generally serve to focus the air through the constricted space when the filter (103) is sufficiently clogged that passage through the space is easier than passing through the filter (103), which serve to inhibit passage of the air through the constricted space when the filter (103) is within its functional tolerances, and which amplify the whistle effect so it can be heard by people that would perform the act of changing the filter.

In the depicted embodiments, the device (200), when assembled as shown in FIG. 1, comprises a loosely barbell shaped structure having an outside portion (203) a central shaft (205) and an inner portion (201). In the depicted embodiment, the two portions are separable from each other by separation of the shaft (205). The outside portion (203) generally has a flat distal base (301) toward its distal end (the outermost portion) which includes a distal hole (303) at a generally central location. The top (307) of the outside portion (301) in the depicted embodiments, is arranged in a slightly tapering, conical fashion, hemispherical, or similar shape on its inside surface (305). In the depicted embodiment, the wall of the top (307) is of generally consistent thickness and therefore the tapered shape is visible externally as in FIG. 1. The resulting structure, therefore is the shape of a hollow cone or hollow hemispheric, hemiparabaloic, hemiellipsoidic, or similar shape with a hole (303) placed central in the base (301) and another hole (309) at the tip or axis, of the top (307) which hole is connected to the interior (225) of the hollow shaft (205). Generally each of the two holes (303) and (309) will have a generally equivalent diameter and be coaxially aligned to provide a cylindrical “path” through the outside portion (203). Air flow into the hole (303) is expected, however, cause air to accumulate inside the hollow portion (325). This top (307) and base (301) are assembled with the base (301) being fit within the top (307) and being held in place by tabs (311). This assembly is generally referred to as an accumulator (317) and while this application should not be read as limited to any method of operation, it is believed that air in the accumulator (317) will begin to rotate and produce vortices. It also is likely accelerated into the hollow shaft (205) as air pressure builds up in the accumulator (312) due to the limited entry hole (303). In operation, it is believed air entering the hole (303) will expand into the hollow internal volume (327) of the accumulator (317) and be directed via the tapered walls (305) where it will generally begin to spin and form a vortex. This serves to speed up the flow of air into the hollow shaft (205). The accumulator (317) may also act as a first resonator amplifying the volume of the whistle generated by the air passing into the outside portion (203).

In an embodiment the base (301) is about 2 centimeters to about 6 centimeters in diameter, more preferably about 4 centimeters in diameter, however it may be larger or smaller in alternative embodiments. The hole is generally about 5 millimeters to about 1 centimeter in diameter, more preferably about 7 millimeters, however, different sized holes may be used. The provided dimensions are preferred because they provide for a consistent whistling effect when used in a variety of residential HVAC systems (100) and with different filter media (113).

The inner portion (201), generally has a lower portion (401) on its inner surface and has a more rounded upper surface (403). The exterior surface (403) is roughly cylindrical, but includes a tapered corner (405) and again includes a hole (407) that is generally central. Like the outside portion (203), the inner portion (201) is generally encloses a hollow interior (425). There will usually be a hole (409) which again communicates with the interior volume (225) of the shaft (205). The lower portion (401) is generally frictionally engaged with the upper surface (403) and held in place by tabs (411).

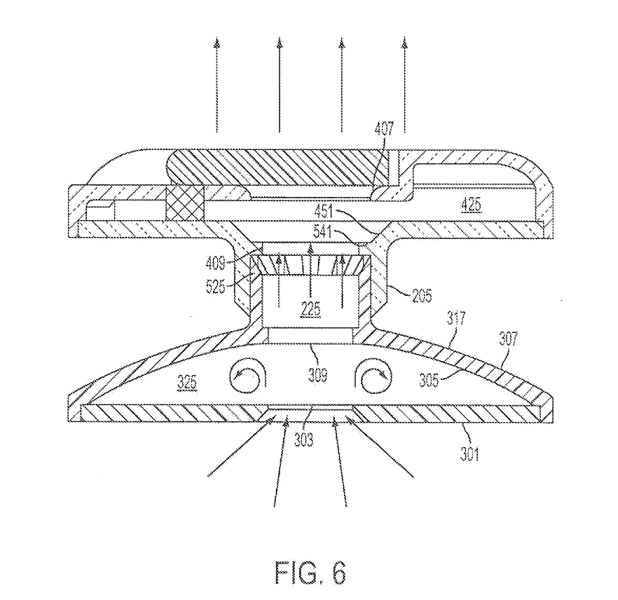

As is best visible in FIG. 6, there is then a outward splayed internal portion (451) which is prior to the entrance to the hollow interior (425) of the inner portion (201). The holes (409) and (407) once again generally present a cylindrical path through the inner portion (201) being of similar size to each other and arranged generally coaxially. As is visible in FIG. 6, air flowing from the central shaft (205) into the inner portion (201) will generally rush across the entrance to the hollow interior (425) with some air flowing into the hollow interior (425). This will generally form the hollow interior (425) into a cavity resonator (e.g. a Helmholtz resonator) for the air flow through the generally cylindrical air flow path formed at the holes (409) and (407) and the hollow interior (525) of the shaft (205).

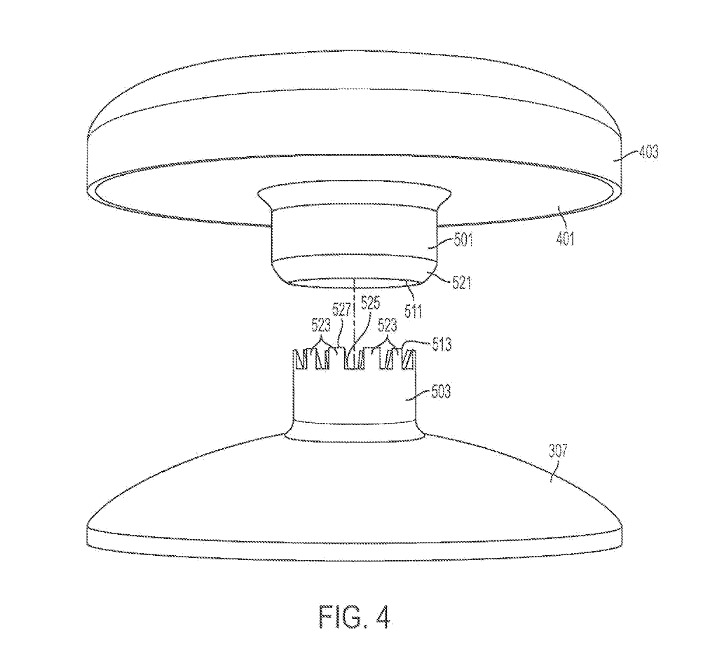

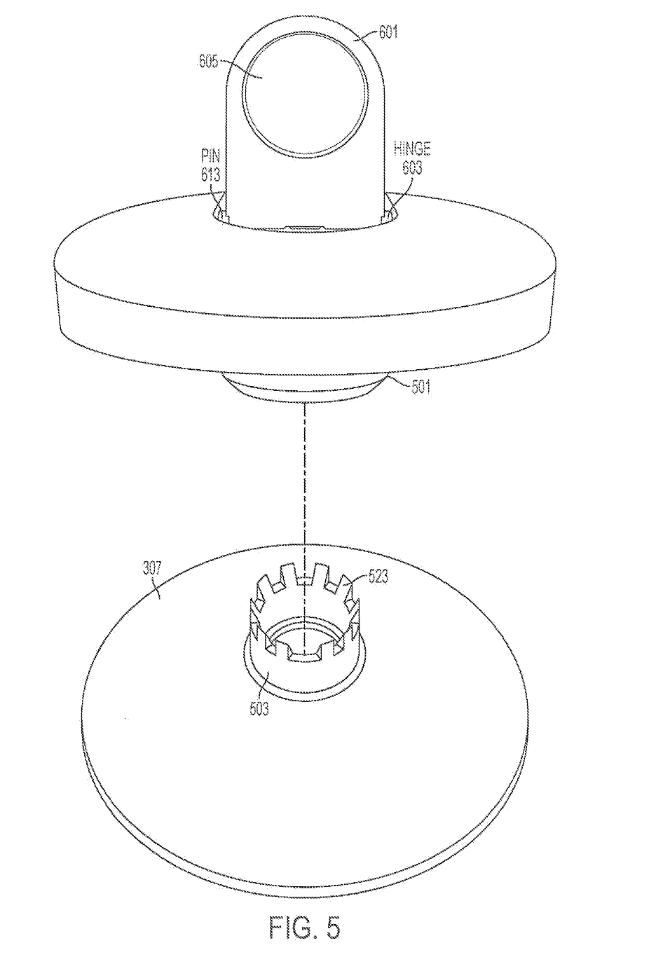

As can be seen in FIGS. 4 and 5, the device (200) generally will be separable into the two portions (203) and (201). The two pieces of the shaft (205) in the depicted embodiment comprise a male connector (503) which is attached to the outside portion (203) and a female connector (501) attached to the inner portion (201). The two connectors (501) and (503) attach by being pressed together in a “press-fit” frictional arrangement as is best seen in FIGS. 1 and 6.

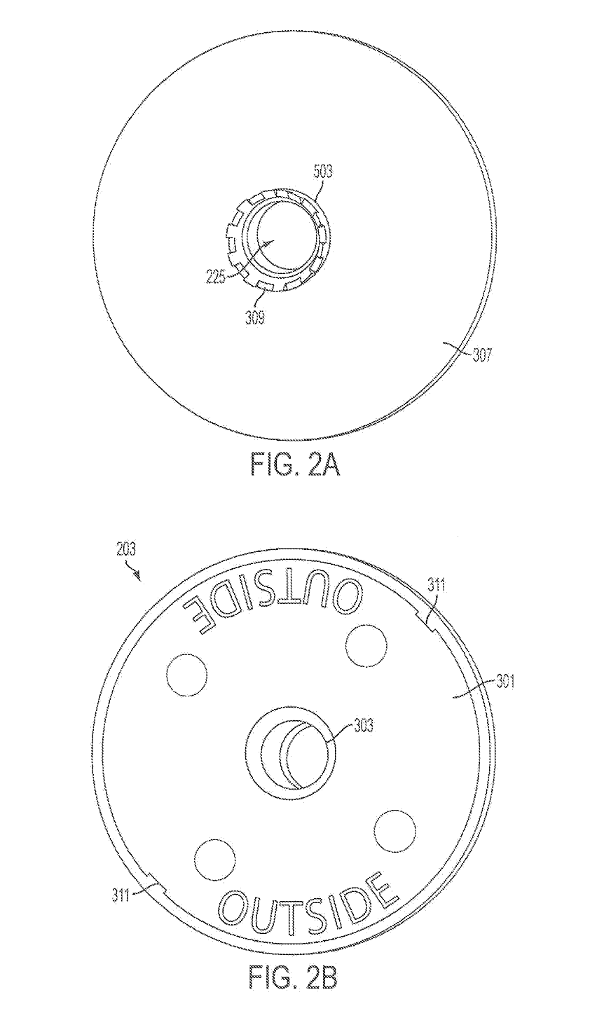

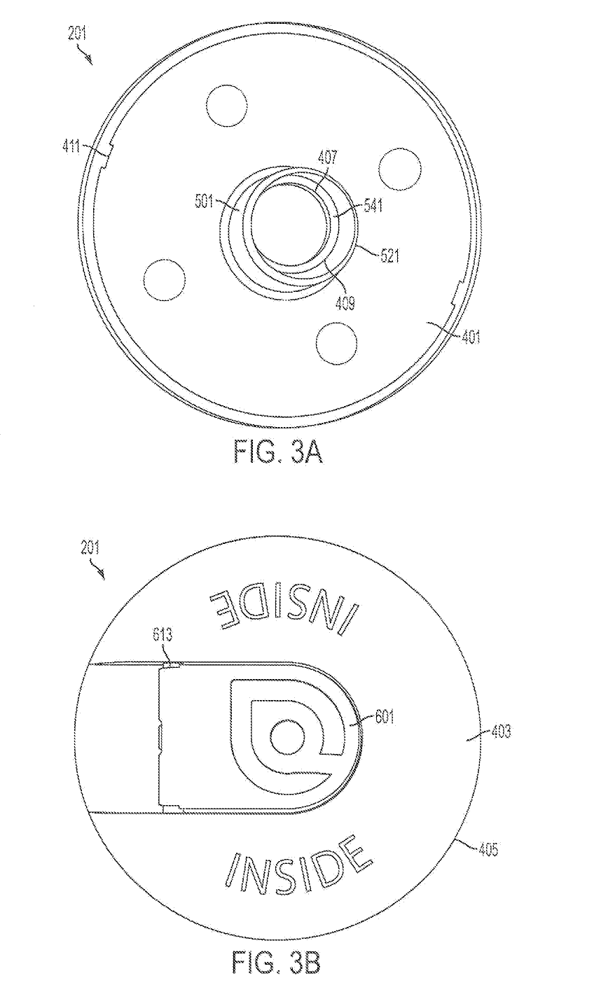

As can also be seen in FIGS. 2 and 3, the shaft (205) is hollow having an internal volume (225). The hollow internal volume (225) extends between the inner portion (201) and outside portion (203) and therefore, when assembled as in FIG. 1, the shaft (205) generally serves to connect the two portions (201) and (203) providing a hollow cylindrical pathway through the device (200). The inner diameter of the shaft (205) will generally be similar to the diameter of the holes (303), (309), (409), and (407) thus providing an air path through the device (200) of generally constant diameter. However, that air path passes through the two larger hollow portions (425) and (325) air in the path can flow into those portions and provide for characteristics of the device (200).

As can be seen in FIG. 4, the two connectors (503) and (501) have slightly different structures, In particular, the distal end (511) of female connector (501) has a smooth, generally tapered surface (521). The tapered surface (521) will generally result in the outside diameter of the distal end (511) being less than the diameter of the rest of the female connector (501). The inside diameter of the female connector (501) will generally be the equivalent of the outside diameter of the male connector (503) so that they form a frictional engagement as indicated in FIG. 6. The female connector (501) may also include a stop (541) which inhibits the male connector (503) from penetrating beyond a certain point.

The proximal end (513) of the male connector (503), however, which is designed to be positioned inside the female connector (501) when the press fit engagement is made, includes a plurality of teeth (523). In the depicted embodiment, the teeth (523) are generally rectangular in form and have a tapered end (525) producing a sharp edge (527) at the extreme proximal location. While teeth (523) are not used in alternative embodiments, teeth (523) can be beneficial during installation. As most filter media (113) comprises some form of fiber, the inclusion of the teeth (523) allows for the male connector (503) to cut through the filter media (113). Similarly, the tapered portion (521) on the female connector (501) can allow for the female connector (501) to better extend into the hole cut into the filter media (113) by the male connector (503) to form the press fit arrangement. The male connector (503) will generally have an exterior diameter of the same size as the interior diameter of the female connector (501) and will have an interior diameter of similar size the holes (303), (309), (409), and (407).

Generally, once the connectors (503) and (501) are placed together, the distance internal to the barbell (L) will generally have a length of about 1 inch. This dimension is selected because the vast majority of filter media (113) used is designed to be placed in a frame (123) which has a transverse width of about one inch. This is commonly referred to in the industry as a “one inch filter” as the filter frame (123) (regardless of the amount, thickness, or positioning of the media (113) in the frame (123)) is designed to fit into an opening of about one inch. It should be recognized that the length (L), while generally being about one inch for use with a one inch filter, can have a variety of different lengths in that range. For example, the length (L) can be about 0.5 to about 1.5 inches and still be useable in a one inch filter. Similarly, for larger filters (for example filters having a four inch wide frame which are commonly called box filters) the length (L) could be about four inches.

Still further, in an alternate embodiment, instead of being positioned so that the shaft (205) runs generally perpendicular to the filter frame (123), the device (200) can be positioned to run generally perpendicular to the sheet forming the filter media (113). This may provide a device (200) where the length (L) is substantially below an inch. In an embodiment, the shaft (525) may not have any appreciable length and the device (200) may be arranged so that the base (401) and the top (307) are in contact if there is no filter media (113) present. In effect, L is zero. In this way, the device (200) could accommodate a very narrow filter media (113).

The flow of air through the device (200) from the base (301) to the upper surface (403) can produce a whistling sound. In particular, as air enters the hole (303) in the base (301) of the outside portion (203), the air may begin to form vortexes in the hollow interior (325). This air is then pushed through the hollow interior (525) of the shaft (205) where the constrained diameter of the shaft (205) provides that the air flow is additionally accelerated. The air will then exit the central shaft (205) passing over the hollow interior (425). Some of the air will flow out through the exit hole (407) while other air will generally flow over the tapered interior portion (451) and into the hollow cavity (425). This flow of air will result in the hollow interior (425) acting as a cavity resonator which will serve to provide amplification to the whistling sound of the air movement.

In use, the device (200) is placed into a standard air filter (103) as shown in FIGS. 1 and 8. The device is installed by separating the two portions (201) and (203) and placing the outside portion (203) on the upstream side (115) of the filter media (113) and the inner portion (201) on the downstream side (117) of the filter media (113). The outside portion (203) is then pushed into the filter media (113). The teeth (525) cut through the filter media (113) or simply force it out of the way. Depending on the thickness and density of the filter media (113), the outside portion (203) may be twisted or rotated so as to enhance the cutting action. In extreme cases, while generally not required, the user could punch through the filter media (113) with a tool to create a starter hole prior to installation.

Once the male connector (503) is sufficiently through the media (113) the inner portion (201) is brought up on the downstream surface (117) and the two connectors (501) and (503) are press fit together. It should be apparent that the friction on the press fit will generally be sufficient to hold the device (200) in place. In an embodiment, however, the filter media (113) at the border of the cut hole may become trapped in the press fit seal to provide for additional friction and a tighter fit.

As should be apparent, when in place the inner surface (401) is generally against the downstream side (117) of the filter media (113) and the proximal portion (307) is generally against the upstream side (115) of the filter media (113). In FIG. 1 this means the filter (103) will occupy the space (L). It should be recognized that the device (200) will generally be arranged perpendicular to the plane of the frame (123), but may not actually be positioned perpendicular to the filter media (113), although in some cases it may be.

As the air exits the device (200) through the hole (407) it will generally be accompanied by a particular acoustic wave or “whistle”. This sound is projected into space (117). In FIG. 8 this is an enclosed space and, thus, generally results in the sound being projected through the duct work (111) and out the registers in the building using the HVAC system (100). The sound is usually easily detected and can be used as an indicator that the air filter (103) needs to be replaced.

In the depicted embodiment, the inner portion (201) includes a door (601) which will serve to cover the air passageway through the device (200). The door (601), is generally mounted on a hinge (603) and is allowed to move between a closed position as shown in FIG. 3B to an open position as shown in FIGS. 1 and 5. In the closed position the door (601) serves to block or close the hole (407), and in the open position the door (601) is spaced from the hole (407) allowing free passage of air from the hole (407). As should be apparent, the door (601) can also occupy a plurality of positions between the open and closed position which can be considered at least partially open The hinge (603) is generally designed to allow for free movement between the two extreme positions and the plurality of positions between.

In the depicted embodiment, the door (601) also includes a weight (605). The weight (605) serves to make the door (601) harder to open and effectively acts as a biasing mechanism or means to hold the door (601) in at least one of the two extreme positions. In the depicted embodiment, the weight (605) will serve to hold the door (601) in the closed position when the door (601) is closed unless the air pressure differential between the inside of the device (200) and the downstream space (117) is sufficient that the air pressure will push the door (601) open. In alternative embodiments, the weight (605) may be replaced by a different type of biasing system or means which serves to provide for a level for force required to open the door (601). These systems and means can comprise springs, weights, frictional resistances, magnets, and other mechanisms which serve to hold the door (601) in position.

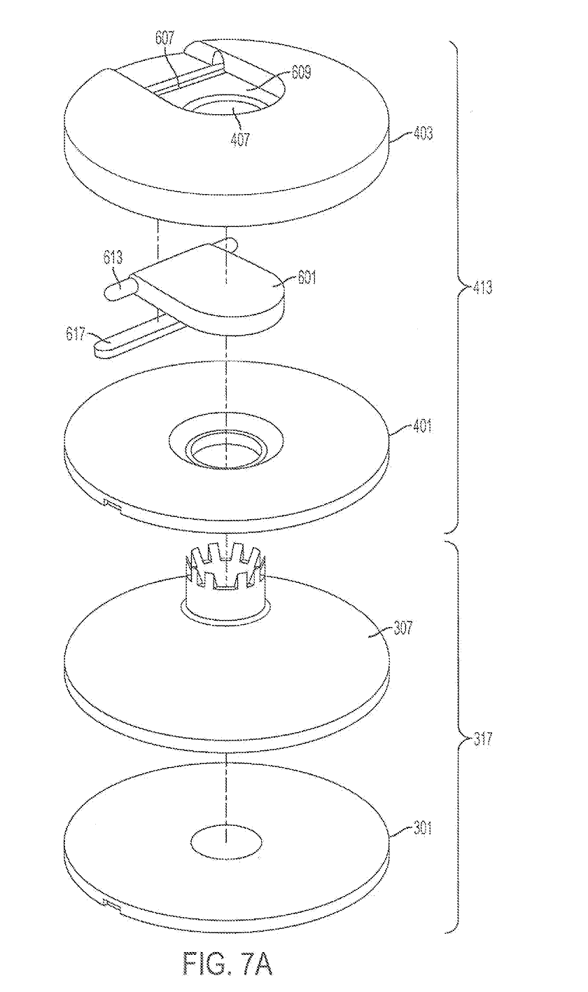

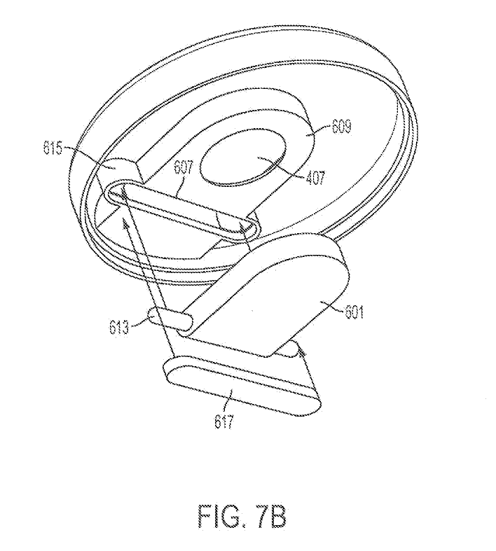

In the depicted embodiment, the weight (605) can also serve to hold the door (601) open. Thus, the door is selectively open or closed. As can be seen best in FIG. 6, the hinge (603) is a simple rotary hinge or other bearing which provides for rotation of the door (601) about a generally fixed axis. In this case, the door (601) includes a pivot (613) which extends into a barrel mount (615) in the upper surface (403) of the inner portion (201). FIGS. 7A and 7B show the arrangement of the hinge components where the door (601) is threaded through a gap (607) placing the pivot (613) in the barrel mount (615). A brace (617) is then placed under the pivot (613) which serves to seal off the bottom of the barrel mount (615) when the brace (617) is held in place by the lower portion (401) being positioned and connected. The door (601) will generally be inhibited from passing into the hollow chamber (425) by having a recessed area (609) into which it rests.

Because the hinge (603) is a simple rotary hinge with free rotation, the door (601) will generally remain in whatever position it is placed. Because the door (601) includes a weight (605), if the device (200) is positioned in the filter media (113) with the hinge (613) placed upward (the position with the left of the inner portion as shown in FIG. 3B above the right portion) gravity will cause the door (601) to swing down and cover the hole (407). However if the device (200) is rotated to an opposing position (generally about 180 degrees) so that the hinge (603) is below the hole (407) (placing the right of FIG. 3B above the left), the door (601) will generally swing and be held open by the force of gravity serving to pull it that direction.

The door (601) provides for the ability to use the device (200) with a variety of different filter media (113). As should be apparent, a higher quality filter media (113) (one that removes a greater percentage of particulates, specifically smaller particulates which is generally one with a higher Minimum Efficiency Reporting Value (MERV)) will generally create a greater air pressure differential between the upstream area (115) and the downstream area (117) than a lower quality filter media (113) will regardless of the amount of material trapped in the filter (103). Further, a lower quality filter (103) could be considered “clogged” to the point of needing to be replaced prior to the air pressure differential even rising to the level that a new higher quality filter (103) starts at. The door (601) allows the determination of when to replace the filter (103) to be specified based on the type of media (113). Thus, the device (200) when used in a lower quality filter may indicate a replacement is necessary at a lower pressure differential than the same device (200) in a higher quality filter. Thus, the device (200) can effectively be used in a variety of filter media (113) and can provide an indication which is dependent on a relative level of dirt within the filter (103), as opposed to a specific determination of raw air pressure differential.

In operation in a lower quality filter (one which traps a lesser percentage of particulates or has a lower MERV), the device (200) will be positioned so that the door (601) (601) hangs open. In these types of filters (103), the air flow through the filter media (113) is generally quite significant and even when these filters (103) become fairly heavily clogged, the pressure differential may not be as much as it is with a new higher quality filter media (113). Thus, by removing the door (601) from the hole (407), the air path through the device (200) is free in all circumstances. Thus, when the filter (103) becomes clogged, even though it may still allow for a significant amount of air movement, the air path through the device (200) will still provide a greater level of movement and the device (200) will readily whistle when the filter (103) accumulates sufficient particulates to require replacement. Thus, the amount of clogging in a filter (103) of this type is generally less than would be expected in a higher quality media (113).

When the device (200) is placed in a higher quality media (113) (one with a higher MERV), the media (113) will generally present a significant obstruction to air movement. In this case, the free air path contemplated above would likely cause the device (200) to whistle even before the media (113) became clogged and the filter (103) reached the end of its useful life. In this situation, the device (200) is positioned with the door (601) closed (generally hanging downward). As should be apparent, this requires a greater differential between the two space (115) and (117) to commence the whistling than in the prior arrangement. Specifically, the differential must be sufficient that the air pressure in the interior of the device (200) can push the weighted door (601) out of the way. Once the door (601) is opened, the air in the device (200) can flow through the device (200) and the whistling will commence. If the door (601) is in place, the air will simply move within the hollow interior and generally will not create resonation. It should be noted that this discussion contemplates that a higher MERV value corresponds to a higher pressure differential. While this is usually the case, it is not required and selective use of the door (601) is based on pressure differentials desired to cause whistling, not necessarily on other factors.

The door's (601) purpose in the closed position is therefore to select the minimum amount of air pressure differential required for the passageway through the device (200) to open. In an embodiment, the door (601) has a mass of about 1 to about 3 grams and preferably has a mass of about 2 grams, even more preferably a mass just over 2 grams such as, but not limited to, 2.01 grams. It has been determined that a door (601) with this mass will begin to open and therefore produce whistling when the filter (103) reaches a point where it should be changed. However, as indicated above, the air pressure does not have to force the door (601) into a completely open position, generally, as the air pressure differential will increase in a smooth fashion, as the filter (103) becomes more and more clogged, the air pressure will generally force the door (601) to open through the myriad of partially open positions.

As would be apparent to one of ordinary skill, the more open the door (601) is, the more air that can pass through the device (200) and therefore, generally the louder the whistling effect will be. Thus, the ability to open the door (601) a large number of different partial amounts provides that the whistling can commence at the time the filter (103) should be replaced, and will become increasing loud should the filter (103) not be replaced. Basically, the device (200) provides for an escalation in the notification if the filter (103) isn't promptly replaced.

Once the device (200) is in place, the filter (103) can be placed in the HVAC system (100) and the system (100) is used normally. It should be apparent that air will attempt to pass through the device (200) from the initial outset of use and the door (601) may slightly open or a slight whistle effect may be produced even initially. However, the device (200) will generally only whistle loudly enough to be easily detected through the registers if the air flow through the device (200) is sufficient to cause resonation and amplification. In effect, without sufficient air flow to generate the resonation, the device (200) may produce a whistling sound, but it is generally not of sufficient volume to be heard clearly over the sound produced by the movement of the air in the duct (111).

Further, even without the door (601) being positioned over the hole (407), if the filter (103) is not replaced after the whistling commences, the air pressure differential will generally continue to increase as the filter (103) becomes more and more clogged. Thus, the whistling effect will generally become louder as more air passes through the hole (407) (the speed of the air flow through the hollow shaft (205) and over the resonator (425) increases) and the device (200) will produce a greater volume of sound as is understood for this type of resonation.

Presumably at some point an individual with control over the HVAC system (100) will find the whistling to be unpleasant or annoying. At this time, this person would presumably purchase or acquire a new filter (103) and replace the old one. The device (200) will generally not be disposed of with the filter (103), but would be removed by separating the two portions (201) and (203) and removing them from the media (113). The device (200) is then reinserted it in the new filter (103) as contemplated above. The device (200) may be washed between installations to remove any material that may have built up on it, if desired. As the device (200) is internal to the filter (103) structure, removal of the device (200) to simply eliminate the annoyance is not much simpler than simply replacing the filter (103) and repositioning the device (200). Thus, it is expected that the device (200) will see increased use over a device (200) which could be remotely shut off. Instead, because the device (200) is mounted to the filter media (113) and is within the duct (111), the filter (103) needs to be at least partially removed to silence the device (200).

While the device (200) contemplated in the embodiment of the FIGS is generally intended for residential use and is sized and shaped for use with a generally 1 inch thick filter (103) of the type commonly used in residences, it should be noted that the device (200) can be made in different sizes to handle different HVAC system (100) filters (103), filter media (113), and ductwork (111). The shaft (205) may be longer to allow for the device to be used on filters (103) of increased thickness as is common in commercial HVAC systems. In order to provide appropriate air flow the diameter of the shaft (205) may also be increased or decreased as the shaft (205) is lengthened or shortened. Further, the device (200) could be designed to go through multiple filters (103) simultaneously.

In a still further embodiment, the portions (203) and (201) can be significantly greater or reduced in diameter, thinner, or thicker, to allow for the device (200) to be easily placed into the filter media (113) and for the filter (103) to be installed into the ductwork (111). It should be recognized that a smaller diameter (such as that discussed previously) is generally preferred as it means the accumulator (317) is not taking up too much of the filter media's (113) upstream face (125) and effecting the operation of the filter (103). In addition to altering the size of the device (200), the amount of the bias on the door (601) (the weight (605)) may also be adjusted as necessary to provide for appropriate resistance to detect clogging and generate a desired volume based thereon. For example, if the device (200) is to be used with an extremely dense filter media (113) (such as may be used in a clean room application) the bias may be increased significantly above the ranges discussed above. Similarly, the shape of the device (200) may also be altered, as appropriate, or be used in different arrangements.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A device for indicating when an air filter should be replaced, the device comprising:
an outside portion, said outside portion comprising an accumulator
an inner portion, said inner portion comprising a resonator;
a hollow shaft connecting said inner portion and said outside portion such that air flows from said accumulator, through said shaft and through said inner portion such that the flow of air from said hollow shaft to said inner portion produces a whistling sound; and
a door, said door being positioned to selectively prevent or allow air from exiting said inner portion.

2. The device of claim 1 wherein said accumulator forms a taper which is connected at a hole to said hollow shaft.

3. The device of claim 2 wherein said accumulator comprises a hollow cone, a base of said cone having a hole in the center.

4. The device of claim 2 wherein said accumulator comprises a hollow hemisphere, a base said hollow hemisphere having a hole in the center.

5. The device of claim 1 wherein said resonator comprises a hollow cylinder.

6. The device of claim 1 wherein said hollow shaft comprises:
a male connector; and
a female connector;
wherein said male connector and said female connector are connected in a press fit relationship to form said hollow shaft.

7. The device of claim 6 wherein said male connector is attached to said outside portion and said female connector is attached to said inner portion

8. The device of claim 6 wherein said male connector comprises teeth.

9. The device of claim 8 wherein said male connector is attached to said outside portion and said female connector is attached to said inner portion

10. The device of claim 9 wherein said teeth are inside said female connector when said male connector and said female connector are in said press fit relationship

11. The device of claim 1 wherein said door inhibits air from exiting said inner portion if the air flow from said inner portion is not sufficiently fast.

12. The device of claim 11 wherein said door is held in said closed position by a biasing mechanism.

13. The device of claim 11 wherein said biasing mechanism is a weight.

14. The device of claim 11 wherein said biasing mechanism is a spring.

15. The device of claim 1 wherein said door can be positioned in one of an open position or a closed position by a user.

16. The device of claim 15 wherein said door includes a weight.

17. The device of claim 16 wherein said weight is used to hold said door in a closed position when said device is placed by said user in an upright orientation.

18. The device of claim 17 wherein said weight is used to hold said door in an open position when said device in placed by said user in an orientation opposite said upright orientation.

19. The device of claim 1 wherein said resonator is a cavity resonator.

20. A combination air filter and device for indicating that the air filter should be replaced, the combination comprising:
an air filter comprising a filter media; and
a notification device comprising:
an outside portion, said outside portion comprising an accumulator;
an inner portion, said inner portion comprising a resonator;
a hollow shaft connecting said inner portion and said outside portion such that air flows from said accumulator, through said shaft and through said inner portion; and
a door, said door being positioned to selectively prevent or allow air from exiting said inner portion;
wherein said outside portion is located on an upstream side of said filter;
wherein said inner portion is located on a downstream side of said filter;
wherein said hollow shaft penetrates said filter media; and
wherein a flow of air through said device produces a whistling sound.
